(19) United States
(12) Patent Application Publication
(10) Pub. No.: US 2015/0100278 A1
(43) Pub. Date: Apr. 9, 2015

(54) SYSTEMS AND METHODS FOR QUANTITATIVE PHASE IMAGING WITH PARTIALLY COHERENT ILLUMINATION

(71) Applicant: GEORGIA TECH RESEARCH CORPORATION, Atlanta, GA (US)

(72) Inventors: Thomas K. Gaylord, Atlanta, GA (US); Micah H. Jenkins, Atlanta, GA (US); Joshua M. Long, Atlanta, GA (US)

(21) Appl. No.: 14/505,565

(22) Filed: Oct. 3, 2014

Related U.S. Application Data
(60) Provisional application No. 61/886,879, filed on Oct. 4, 2013.

(51) Int. Cl. G01N 21/45; G01B 9/02; G06F 17/14

(52) U.S. Cl. CPC G01N 21/45; G06F 17/142; G01B 9/02041; G01N 2021/458; G01N 2201/061; G01N 2201/08
USPC 702/189

(57) ABSTRACT

Systems and methods for quantitative phase imaging are disclosed. In one embodiment, a method includes acquiring a through-focal series of defocused images of an object illuminated with a partially coherent light source; calculating a plurality of estimates of longitudinal intensity derivatives for respective fittings of the series of defocused images; recovering a phase estimate for each respective estimate of the longitudinal intensity derivative by solving a transport of intensity (TIE) equation; filtering the recovered phase estimates to produce component parts of an overall phase estimate; and forming an overall phase image by addition of the filtered phase estimates.

### CROSS-REFERENCE TO RELATED APPLICATIONS

This application claims priority to U.S. Provisional Patent Application No. 61/886,879, filed Oct. 4, 2013 and entitled “Method and Apparatus for Quantitative Phase Imaging in Partially Coherent Illumination,” the contents of which are fully incorporated herein by reference.

Some references, which may include patents, patent applications, and various publications, are cited in a reference list and discussed in the disclosure provided herein. The citation and/or discussion of such references is provided merely to clarify the description of the present invention and is not an admission that any such reference is “prior art” to any aspects of the present invention described herein. All references cited and discussed in this specification are incorporated herein by reference in their entireties and to the same extent as if each reference was individually incorporated by reference. In terms of notation, hereinafter, “[n]” represents the nth reference cited in the reference list. For example, [4] represents the 4th reference cited in the reference list, namely, Z. Wang, L. Millet, M. Mir, H. Ding, S. Unarununotai, J. Rogers, M. U. Gillette, and G. Popescu, “Spatial light interference microscopy (SLIM),” Opt. Express 19, 1016-1026 (2011).

### STATEMENT OF RIGHTS UNDER FEDERALLY-SPONSORED RESEARCH

The present invention was made in part with U.S. Government support under grant no. DGE-1148903, awarded by the National Science Foundation. The U.S. Government has certain rights in the present invention pursuant to this support.

### BACKGROUND

1. Technical Field

The present invention relates generally to quantitative phase imaging and specifically to quantitative phase imaging with partially coherent illumination.

2. Background of Related Art

Phase imaging can be of critical importance for a variety of applications, for example in biomedical study and optical metrology, since many objects of interest are not strongly absorbing yet induce significant phase shifts. A number of conventional approaches are used for qualitative and quantitative phase imaging [1-3]. Quantitative methods can reveal structural information directly, for example in the study of cellular processes [4].

Quantitative phase imaging (QPI) is an emerging field of study which quantifies structural information in transparent objects without utilizing exogenous contrast. In its basic form, QPI images an object's optical path length or its refractive-index variation integrated along the optical axis. Prior to the development of QPI, phase contrast and differential interference contrast microscopy were used to image refractive-index variations. These methods, while useful, may only provide qualitative information regarding the optical phase delay of a sample. Similarly, although fluorescence microscopy provides targeted structural information, using exogenous contrast agents such as fluorophores may alter the state of the sample and can result in death due to overexposure for biological samples.

QPI has a variety of important uses, for example biological applications and for characterization of optical fiber [5] and semiconductors [6]. Many current applications of QPI are biological in nature, with experiments being performed for fundamental research [7-9] and clinical diagnostics [10-12]. For example, QPI has been used to study cell migration and adhesion by detecting cytoskeletal dynamics composed of actin and tubulin microtubule networks [7]. QPI has also been used to quantify intracellular mass transport in live cells [8]. QPI has offered some answers to questions regarding the need for growth regulatory systems in adherent cells by measuring growth in single Escherichia coli cells [9]. In the realm of clinical diagnostics, QPI has been used as an alternative to flow cytometry for red blood cell screening and morphology [10-11]. Likewise, QPI can be used by pathologists in combination with H&E staining to aid in cancer diagnosis through tissue biopsy imaging [12].

Many conventional QPI methods are based on interferometry and can require explicit control over reference and object beams in order to derive phase information from measured interferograms [3]. By contrast, propagation-based phase retrieval methods may be experimentally simple since the only input data may be images taken at varying propagation distances using traditional imaging hardware [13, 14]. More specifically, deterministic phase retrieval based on the transport-of-intensity equation (TIE) can be useful due to its ability to recover the optical path length of an object when the illumination is partially (both temporally and spatially) coherent and the phase is not well-defined over the field of view [15]. This is to be contrasted with the strict spatial coherence requirements inherent in most phase imaging methods, and can be of significant practical importance for situations in which coherent sources are either unavailable or not economically viable. Another important consequence of this compatibility is the potential for improved spatial resolution over coherent methods.

Derived from the paraxial scalar wave equation, the TIE as given by Eq. (1) specifies the relationship between the unknown phase φ and the derivative of intensity along the optical axis z, where λ̅ is the spectrally weighted mean wavelength and ∇_{⊥} is the gradient operator in the lateral dimensions (x, y) represented by the position vector r=x\hat{x}+yŷ [14]:

$$\frac{\partial I ( r , z )}{\partial z} = - ( \frac{\overline{λ}}{2 π} ) {∇}_{⊥} \cdot [ I ( r , z ) {∇}_{⊥} φ ( r , z ) ] . \qquad ( 1 )$$

The intensity derivative cannot be measured directly and must be approximated typically using finite difference methods. Conventionally, the z derivative is approximated by subtracting two symmetrically defocused images [16]. One of the major reasons for which TIE phase imaging, despite its many desirable attributes, has not yet been widely adopted is an inherent trade-off between noise and spatial resolution in the choice of the defocus distance [17]. Choosing a small defocus distance may improve resolution at the expense of dramatically increased noise susceptibility, while choosing a large defocus distance may reduce noise susceptibility at the expense of degraded resolution.

In order to overcome this trade-off, there has been an increased effort to improve the intensity derivative estimate by utilizing information recorded in multiple defocused planes [18-21]. Among these, methods that decompose the problem in the lateral spatial frequency domain and estimate each Fourier component of the z derivative with an appropriately chosen combination of finite difference approximation can be effective because they balance the effects of noise and diffraction induced nonlinearity over a wide range of length scales [17, 21]. Methods such as these may be termed multifilter phase imaging (MFPI) methods due to their use of multiple spatial frequency filters in post-measurement processing to produce a composite phase image. The choice for the finite difference approximations may be determined by the dynamics of wave propagation between defocused planes and is therefore sensitive to the level of spatial coherence of the incident illumination.

Existing MFPI methods have only been derived for the spatially coherent cases [17, 21], and are not adapted to match the physics of partially coherent wave propagation, the regime for which the TIE method may be particularly well-suited. As a result there is a need for improved systems and methods to address the above mentioned deficiencies. It is with respect to these and other considerations that embodiments of the present invention are directed.

### SUMMARY

Systems and methods according to some embodiments of the present invention address the above-mentioned deficiencies of conventional approaches by providing a multifilter approach for implementation with partially spatially coherent illumination. Some embodiments of the present invention provide systems and methods for quantitative phase imaging to accurately estimate phase over a wide range of length scales using illumination from an extended incoherent source.

According to one aspect, the present invention relates to a method of quantitative phase imaging. In one embodiment, the method includes acquiring a through-focal series of defocused images of an object illuminated with a partially coherent light source; calculating a plurality of estimates of longitudinal intensity derivatives for respective polynomial or other fittings of the series of defocused images; recovering a phase estimate for each respective estimate of the longitudinal intensity derivative by solving a transport of intensity (TIE) equation; filtering the recovered phase estimates to produce component parts of an overall phase estimate; and forming an overall phase image by addition of the filtered phase estimates.

The object can be illuminated with Köhler illumination from an extended incoherent source. Acquiring the through-focal series of defocused images can include sampling the images at equally or unequally spaced intervals placed symmetrically about the in-focus position of the object. Acquiring the through-focal series of defocused images can include collecting the defocused images in parallel using a plurality of detectors and one or more beam splitters.

Calculating the plurality of estimates of the longitudinal intensity derivative can include applying differentiation filters. The differentiation filters can be Savitzky-Golay differentiation filters. Applying the differentiation filters can include applying n differentiation filters having a length of 2n+1 and orders corresponding to odd numbered integers from 1 to 2n−1, where n is an integer. Recovering the phase estimate for each respective estimate of the longitudinal intensity derivative by solving the TIE equation can include solving the TIE equation using one or more of Fourier-based methods, Green's function methods, multi-grid methods, and Zernike methods.

Filtering the phase estimates to produce the component parts of the overall phase estimate can include applying Fourier-based functions. Filtering the phase estimates to produce the component parts of the overall phase estimate can include applying a low-pass filter to the first degree phase estimate, a high-pass filter to the 2n−1 degree phase estimate, and band-pass filters for degrees other than the first degree phase estimate and the 2n−1 degree phase estimate. Each of the low-pass filter, high-pass filter, and band-pass filters can include a binary masking filter. The low-pass filter, high-pass filter, and band-pass filters can be selected according to filter cut-off frequencies coincident with the frequency at which the ratio of a corresponding phase contrast transfer function to the weakly-defocused phase contrast transfer function falls to a predetermined value for balancing signal-to-noise ratio and spatial resolution.

According to another aspect, the present invention relates to a system for quantitative phase imaging. In one embodiment, the system includes a partially coherent light source configured to illuminate an object; an image acquisition device configured to acquire a through-focal series of defocused images of the object illuminated with the partially coherent light source, a memory device; and a processor coupled to the image acquisition device and the memory device. In one embodiment, the processor is configured to execute instructions stored in the memory device to cause the system to calculate a plurality of estimates of longitudinal intensity derivatives for respective polynomial or other fittings of the series of defocused images; recover a phase estimate for each respective estimate of the longitudinal intensity derivative by solving a transport of intensity (TIE) equation; filter the recovered phase estimates to produce component parts of an overall phase estimate; and form an overall phase image by adding the filtered phase estimates.

The image acquisition device can include one or more beam splitters in optical communication with a plurality of detectors configured such that a plurality of the through-focal series of defocused images are collected in parallel. The image acquisition device can include an object translation stage, and acquiring the through-focal series of defocused images can include applying one or more defocus aberrations using the object translation stage.

The image acquisition device can include an objective scanner, and applying the through-focal series of defocused images can include applying one or more defocus aberrations using the objective scanner. The image acquisition device can include an infinity corrected optical system.

Acquiring the through-focal series of defocused images can include sampling the images at equally or unequally spaced intervals placed symmetrically about the in-focus position of the object. Calculating the plurality of estimates of the longitudinal intensity derivative can include applying n differentiation filters having a length of 2n+1 and orders corresponding to odd numbered integers from 1 to 2n−1, where n is an integer. The differentiation filters can be Savitsky-Golay differentiation filters.

Recovering the phase estimate for each respective estimate of the longitudinal intensity derivative by solving the TIE equation can include solving the TIE equation using one or more of Fourier-based methods, Green's function methods, multi-grid methods, and Zernike methods.

Filtering the phase estimates to produce the component parts of the overall phase estimate can include applying Fourier-based functions. Filtering the phase estimates to produce the component parts of the overall phase estimate can include applying a low-pass masking filter to the first degree phase estimate, a high-pass masking filter to the 2n−1 degree phase estimate, and band-pass masking filters for degrees other than the first degree phase estimate and the 2n−1 degree phase estimate. The low-pass filter, high-pass filter, and band-pass filters can be selected according to filter cut-off frequencies coincident with the frequency at which the ratio of a corresponding phase contrast transfer function to the weakly-defocused phase contrast transfer function falls to a predetermined value for balancing signal-to-noise ratio and spatial resolution.

According to another aspect, the present invention relates to a non-transitory computer-readable medium storing instructions that, when executed by a processor, cause a computer to perform a method for quantitative phase imaging. In one embodiment, the method includes acquiring a through-focal series of defocused images of an object illuminated with a partially coherent source; calculating a plurality of estimates of longitudinal intensity derivatives for respective polynomial or other fittings of the series of defocused images; recovering a phase estimate for each respective estimate of the longitudinal intensity derivative by solving a transport of intensity (TIE) equation; filtering the recovered phase estimates to produce component parts of an overall phase estimate; and forming an overall phase image by adding the filtered phase estimates.

Acquiring the through-focal series of defocused images comprises sampling the images at equally or unequally spaced intervals placed symmetrically about the in-focus position of the object. Acquiring the through-focal series of defocused images may comprise collecting the defocused images in parallel.

Calculating the plurality of estimates of the longitudinal intensity derivative can include applying n Savitzky-Golay differentiation filters having a length of 2n+1 and orders corresponding to odd numbered integers from 1 to 2n−1, where n is an integer. Filtering the phase estimates to produce the component parts of the overall phase estimate can include applying a low-pass masking filter to the first degree phase estimate, a high-pass masking filter to the 2n−1 degree phase estimate, and band-pass masking filters for degrees other than the first degree phase estimate and the 2n−1 degree phase estimate. The low-pass filter, high-pass filter, and band-pass filters can be selected according to filter cut-off frequencies coincident with the frequency at which the ratio of a corresponding phase transfer function to the weakly-defocused phase contrast transfer function falls to a predetermined value for balancing signal-to-noise ratio and spatial resolution.

Filtering the phase estimates to produce the component parts of the overall phase estimate can include applying Fourier-based functions.

The foregoing and other objects, features, aspects, and advantages of the present invention will become more apparent from the following detailed description of the present invention when taken in conjunction with the accompanying drawings.

### BRIEF DESCRIPTION OF THE DRAWINGS

Reference will now be made to the accompanying drawings, which are not necessarily drawn to scale, and wherein:

FIG. 1 is a block diagram showing processes of quantitative phase imaging according to an embodiment of the present invention;

FIG. 2 is a diagram of an imaging system according to an embodiment of the present invention;

FIG. 3 is a flow diagram showing operations of a method for quantitative phase imaging according to an embodiment of the present invention;

FIG. 4 is a block diagram showing processes of multifilter phase imaging;

FIG. 5 (a-c) shows plots of normalized phase contrast transfer functions (PCTFs) for various Savitzky-Golay differential filter (SGDF) orders and coherence parameters;

FIG. 6 shows plots of normalized cut-off frequencies of spatial filters for various orders and coherence parameters;

FIG. 7 (a-c) shows plots of phase transfer functions (PTFs) for various orders and coherence parameters;

FIG. 8 shows a simulated phase object;

FIG. 9 shows phases recovered for simulated intensity images using various SGDF orders and coherence parameters;

FIG. 10 shows a phase recovered using coherent MFPI (MFPI-C) on partially coherent intensity data;

FIG. 11 (a-c) shows phase root mean squared errors (RMSE) as a function of normalized noise standard deviation for various orders and coherence parameters, compared with partially coherent MFPI (MFPI-PC) and MFPI-C results;

FIGS. 12A (a-b) and 12B (c-d) show visible transmission grating phase measurement results;

FIGS. 13A (a-f) and 13B (g-l) show various representations of optical fiber tomography data processed using conventional TIE recovery, MFPI-C, and MFPI-PC methods; and

FIG. 14 is a computer architecture diagram for a computing system capable of implementing one or more embodiments of the present invention.

This patent application contains at least one drawing executed in color. Copies of the application with color drawing(s) will be provided by the Office upon request and payment of the necessary fee.

### DETAILED DESCRIPTION

The following detailed description is directed to systems and methods for quantitative phase imaging. Although exemplary embodiments of the present invention are explained in detail, it is to be understood that other embodiments are contemplated. Accordingly, it is not intended that the present invention is limited in its scope to the details of construction and arrangement of components set forth in the following description or illustrated in the drawings. The present invention is capable of other embodiments and of being practiced or carried out in various ways. Also, in describing the preferred embodiments, specific terminology will be resorted to for the sake of clarity.

It must also be noted that, as used in the specification and the appended claims, the singular forms “a,” “an” and “the” include plural referents unless the context clearly dictates otherwise.

Also, in describing the preferred embodiments, terminology will be resorted to for the sake of clarity. It is intended that each term contemplates its broadest meaning as understood by those skilled in the art and includes all technical equivalents that operate in a similar manner to accomplish a similar purpose.

Ranges may be expressed herein as from “about” or “approximately” one particular value and/or to “about” or “approximately” another particular value. When such a range is expressed, another embodiment includes from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Method steps may be performed in a different order than those described herein. Similarly, it is also to be understood that the mention of one or more components in a device or system does not preclude the presence of additional components or intervening components between those components expressly identified.

In the detailed description, references are made to the accompanying drawings that form a part hereof and that show, by way of illustration, specific embodiments or examples. In referring to the drawings, like numerals represent like elements throughout the several figures.

In some embodiments of the present invention, systems and methods provide for producing accurate, high-resolution images of the optical path delay associated with objects of complex refractive index illuminated with partially coherent radiation. A defocused series of images can be measured and processed to improve spatial resolution and noise resistance in the phase recovered via the transport-of-intensity equation (TIE). In some embodiments, phase images of objects with spatially varying complex refractive index can be produced, using imaging systems for which the incident radiation approximately obeys a scalar paraxial wave equation and a defocus aberration may be applied. Example forms of radiation include, but are not limited to, electromagnetic waves in the microwave, terahertz, infrared, visible, ultra-violet, and x-ray regimes as well as matter waves or electron waves. The incident radiation can be produced by a coherent, partially coherent, or incoherent source of finite spatial and spectral extent. In some embodiments of the present invention, an object to be imaged is illuminated by Köhler illumination from an extended incoherent source. In circumstances where the phase of the wave field is not well-defined, the phase image can correspond to the spatial distribution of optical path delay associated with the complex object.

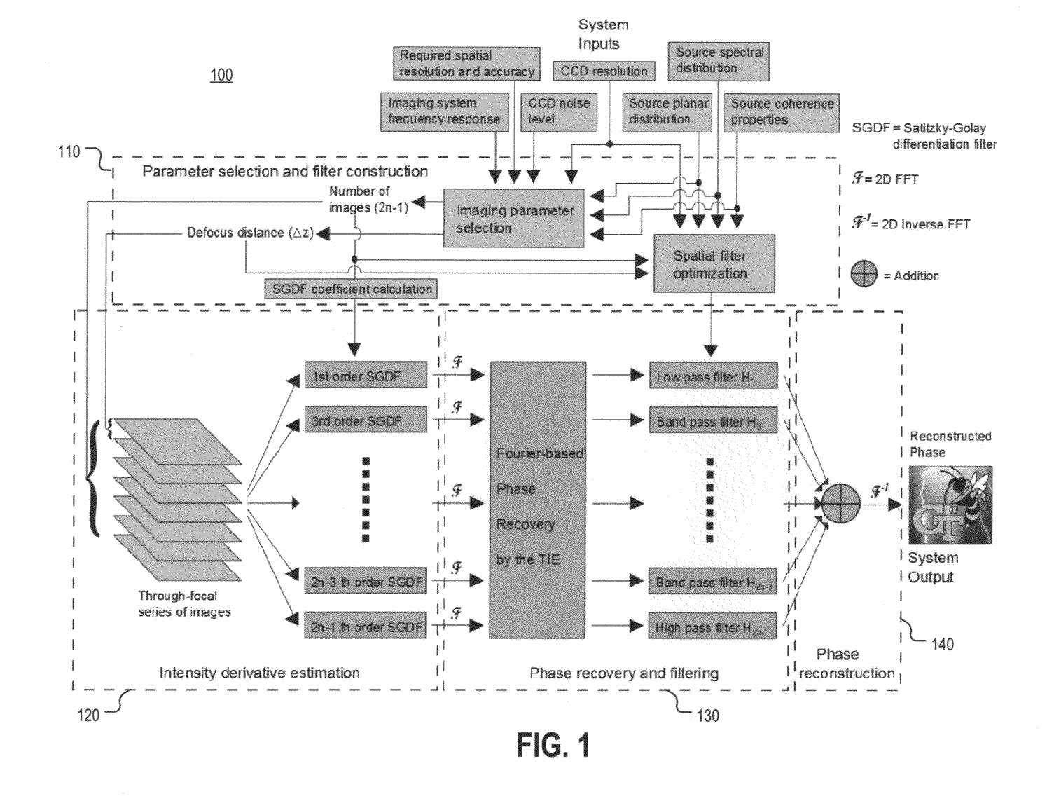

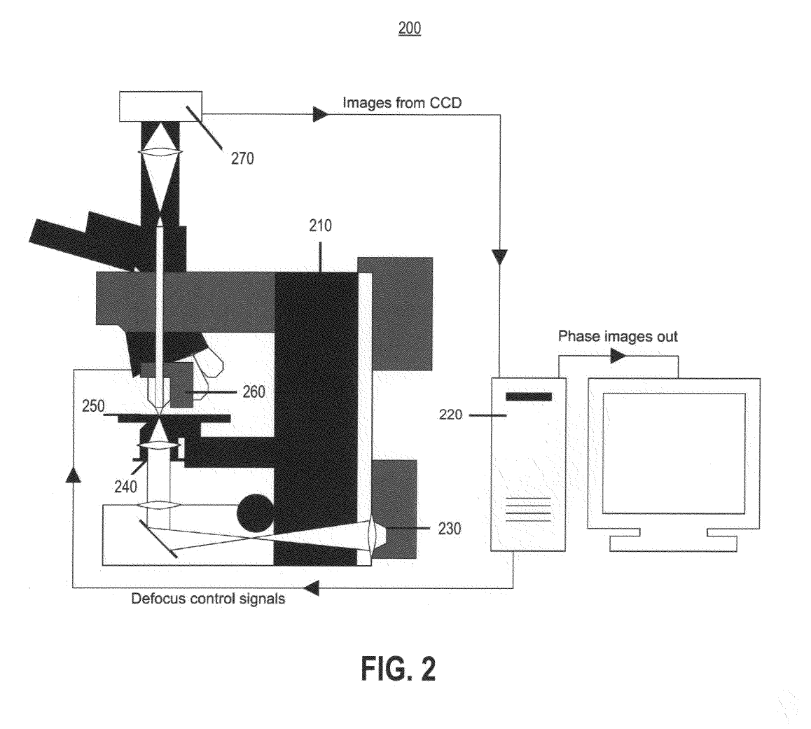

FIG. 1 is a block diagram that illustrates processing of a through-focal series of images according to an embodiment of the present invention. As shown at 110, prior to measurement, the total number of images and distance between images may be selected based on known system characteristics and constraints, such as source spatial and spectral distributions, source coherence properties, detector noise level, detector resolution, required spatial resolution and accuracy, and the frequency response of the imaging system (collectively “System Inputs”). A through-focal series of defocused images can be acquired by sampling at equally spaced intervals or unequally spaced intervals placed symmetrically about the in-focus position of the object. The series of images may be produced using the imaging system 200 shown in FIG. 2, for example.

As shown at 120, after an image set of half length n and full length 2n+1 has been recorded, n estimates of the longitudinal intensity derivative for respective images of the series can be constructed by applying differentiation filters (where n is a positive integer). In particular, in the embodiment shown in FIG. 1, n Savitzky-Golay differentiation filters (SGDF) of length 2n+1 and orders 1, 3, . . . , 2n˜1 are applied to each pixel in the field of view. The SGDF filters can be applied by multiplying the defocused images by pre-calculated coefficients corresponding to SGDFs of various orders during this intensity derivative estimation stage shown at 120.

During the phase recovery and filtering stage shown at 130, each estimate of the intensity derivative can be processed using Fourier-based procedures based on the TIE to recover an associated phase estimate. These phase estimates can then be filtered in the lateral spatial frequency domain to produce component parts of the overall phase estimate. A low pass masking filter can be used on the first degree phase estimate and a high pass masking filter can be used on the 2n−1 degree phase estimate. Band pass masking filters can be used for all other degrees. The cutoff frequencies which define the filter boundaries can depend on the definition of bandwidth imposed on the differentiation filters evaluated in the lateral frequency plane with a relationship governed by wave diffraction. The low pass, high pass, and band pass masking filters can be selected according to filter cut-off frequencies coincident with the frequency at which the ratio of a corresponding phase contrast transfer function to the weakly-defocused phase contrast transfer function falls to a predetermined value for balancing signal-to-noise ratio and spatial resolution.

The characteristics of the filters used can depend on factors including source spatial and spectral distributions, source coherence properties, detector resolution, total number of images, and the defocus distance. The source can be approximated as uniform, circular, and delta-correlated. Accordingly, the filters are radially symmetric with cutoff frequencies dependent on the condenser numerical aperture. As the condenser numerical aperture increases, the cutoff frequencies decrease and their respective ratios are modified.

In the final reconstruction stage shown at 140, the overall phase estimate can be reconstructed by adding together all of the filtered phase estimates corresponding to Savitzky-Golay differentiation filters of various orders. Each Fourier component of the overall phase can thereby be recovered via an appropriate combination of estimates of the intensity derivative. Processing the through-focal series in this manner can improve both spatial resolution and noise immunity, and can exceed the performance obtainable through the use of one differentiation order only.

It should be recognized that other forms of radiation beyond those in embodiments discussed above may be used, provided there are optical elements and detectors available to form corresponding imaging systems. The radiation source may possess various degrees of coherence provided each coherent mode, under coherent mode decomposition, approximately obeys a scalar paraxial wave equation. For example, tube sources may be used in place of microfocus or synchrotron sources in soft or hard x-ray microscopy, which may thereby reduce system cost and complexity for certain applications. Also, although a circular aperture may be used in embodiments described above, the present invention is not limited to sources of any particular shape, since the lateral filters used in processing may be uniquely determined by the source properties. In addition, the image may be recorded by a CCD, CMOS detector, or other detector which is sensitive to the intensity of the incoming wave.

FIG. 2 illustrates an imaging system 200 in accordance with an embodiment of the present invention. As shown, a visible-light microscope with infinity-corrected optics 210 utilizes bright field illumination to image a sample 250, which may contain both amplitude and phase variations, onto a rectangular CCD detector plane 270. Light from a mercury arc lamp 230 is diffused, filtered, and imaged onto the front focal plane of a condenser lens to produce a uniform distribution of incoherently emitting point sources. A circular aperture 240 can control the range of illumination angles and may be set to its smallest diameter for optimal performance. A piezoelectric scanner 260 can translate the microscope objective along the optical axis to produce a through-focal series of images at the detector plane 270. An odd number of equally or unequally spaced images, placed symmetrically about a central in-focus image, are recorded. A software program may execute on a computer 220 for automating the steps of defocusing, image capture and storage, and image processing to produce a quantitative phase image.

In the embodiment shown in FIG. 2, a piezoelectric-driven microscope objective scanner is used in concert with infinity-corrected optics to apply defocus aberrations. However, it should be recognized that alternative methods may be used to defocus the sample. If, for example, a piezoelectric scanner and/or infinity-corrected optics are not available, the object position may be defocused by adjusting a translation stage either manually or using a stepper (or ultrasonic) motor. Mechanical defocusing may be too coarse for applications requiring high accuracy and speed for which electrically tunable lenses with variable focal lengths may be effective. For even higher speed applications, multiple detectors may be used in parallel at predetermined defocused positions by placing beam splitters in the parallel path of an infinity-corrected microscope, such that the time between frames may only be limited by a single exposure time and a processing delay. Due to the relatively relaxed coherence requirements, exposure times may be shorter than comparable techniques which require either spatial or spectral filtering of the source. The processing delay can also be short due to the use of simple arithmetic as well as fast Fourier transform operations.

Although some embodiments described above use equally spaced images for processing and subsequent phase retrieval, unequally spaced intervals may be used to modify the frequency responses of both the longitudinal intensity filters and their corresponding lateral phase filters. If more flexibility is required, the filters may also be adjusted to accommodate continuous scanning as opposed to step scanning, allowing the sample or objective to float continuously with its position being monitored. Also, other methods of transport-of-intensity based phase recovery may be used in place of the Fourier-based methods described above, for example multi-grid [16], Zernike polynomial [17], or Green's function methods [18].

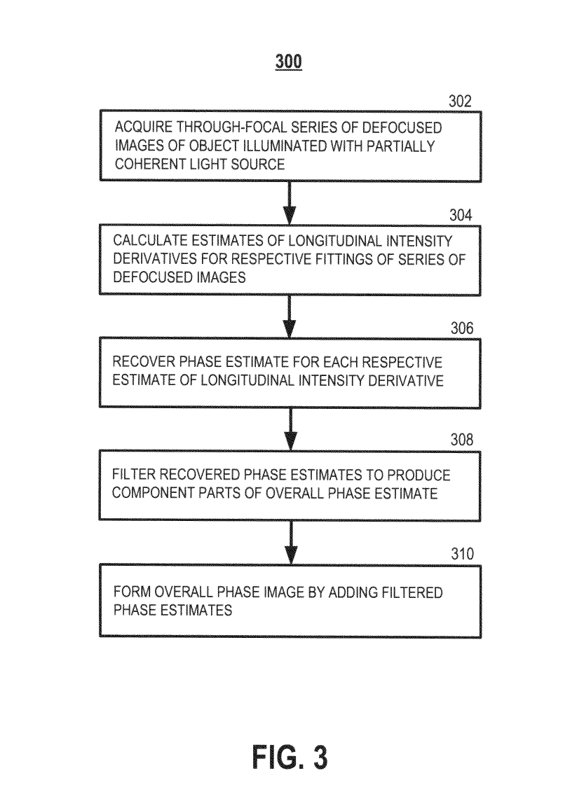

FIG. 3 is a flow diagram illustrating operations of a method 300 for quantitative phase imaging according to an embodiment of the present invention. At block 302, a through-focal series of defocused images are acquired of an object illuminated with a partially coherent light source. The object may be illuminated, for example, by Kohler illumination from an extended incoherent source. At block 304, a plurality of estimates of longitudinal intensity derivatives are calculated for respective fittings of the series of defocused images. Following block 304, at block 306 a phase estimate is recovered for each respective estimate of the longitudinal intensity derivative by solving a transport of intensity (TIE) equation. At block 308, the recovered phase estimates are filtered to produce component parts of an overall phase estimate. Next, at block 310, an overall phase image is formed by addition of the filtered phase estimates.

Acquiring the through-focal series of defocused images (block 302) can include sampling the images at equally or unequally spaced intervals placed symmetrically about the in-focus position of the object, and can include collecting the defocused images in parallel using a plurality of detectors and one or more beam splitters. Calculating the plurality of estimates of the longitudinal intensity derivative (block 304) can include applying differentiation filters, which can be Savitzky-Golay differentiation filters. Applying the differentiation filters can include applying n differentiation filters having a length of 2n+1 and orders corresponding to odd numbered integers from 1 to 2n−1, where n is an integer.

Filtering the phase estimates to produce the component parts of the overall phase estimate (block 308) can include applying a low-pass filter to the first degree phase estimate, a high-pass filter to the 2n−1 degree phase estimate, and band-pass filters for degrees other than the first degree phase estimate and the 2n−1 degree phase estimate. Each of the low-pass filter, high-pass filter, and band-pass filters can be a binary masking filter. The low-pass filter, high-pass filter, and band-pass filters can be selected according to filter cut-off frequencies coincident with the frequency at which the ratio of a corresponding phase contrast transfer function to the weakly-defocused phase contrast transfer function falls to a predetermined value for balancing signal-to-noise ratio and spatial resolution. Filtering the phase estimates to produce the component parts of the overall phase estimate (block 308) can include applying Fourier-based functions.

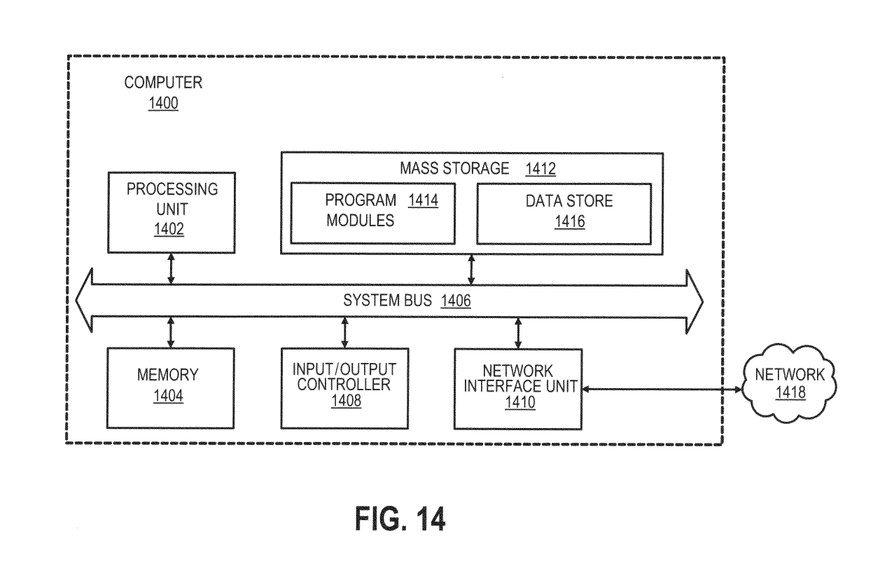

Some aspects of the present invention can be implemented with the use of a computer, and FIG. 14 provides a diagram for a general computer 1400 capable of implementing various aspects of one or more embodiments of the present invention. For example, the computer 1400 may be configured to perform operations shown in FIGS. 1, 3, and 4, and the computer 220 shown in FIG. 2 may include some or all of the components of the computer 1400. As shown, the computer 1400 includes a processing unit 1402, a system memory 1404, and a system bus 1406 that couples the memory 1404 to the processing unit 1402. The computer 1400 further includes a mass storage device 1412 for storing program modules. The program module 1414 may include modules executable to perform one or more functions associated with example embodiments illustrated in FIGS. 1-14, for example one or more operations of the embodiments shown in FIGS. 1, 3, and 4. The mass storage device 1412 further includes a data store 1416. The mass storage device 1412 is connected to the processing unit 1402 through a mass storage controller (not shown) connected to the bus 1406. The mass storage device 1412 and its associated computer storage media provide non-volatile storage for the computer 1400. Although the description of computer-readable storage media contained herein refers to a mass storage device, such as a hard disk or CD-ROM drive, it should be appreciated by those skilled in the art that computer-readable storage media can be any available computer storage media that can be accessed and read by the computer 1400.

By way of example, and not limitation, computer-readable storage media may include volatile and non-volatile, removable and non-removable media implemented in any method or technology for storage of information such as computer-storage instructions, data structures, program modules, or other data. For example, computer-readable storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 1400. Computer-readable storage media as described herein does not include transitory signals.

According to various embodiments, the computer 1400 may operate in a networked environment using logical connections to remote computers through a network 1418. The computer 1400 may connect to the network 1418 through a network interface unit 1410 connected to the bus 1406. It should be appreciated that the network interface unit 1410 may also be utilized to connect to other types of networks and remote computer systems. The computer 1400 may also include an input/output controller 1408 for receiving and processing input from a number of input devices. The bus 1406 may enable the processing unit 1402 to read code and/or data to/from the mass storage device 1412 or other computer-storage media. The computer-storage media may represent apparatus in the form of storage elements that are implemented using any suitable technology, including but not limited to semiconductors, magnetic materials, optics, or the like.

The program module 1414 may include software instructions that, when loaded into the processing unit 1402 and executed, cause the computer 1400 to provide functions relating to coreference resolution. The program module 1414 may also provide various tools or techniques by which the computer 1400 may participate within the overall systems or operating environments using the components, flows, and data structures discussed throughout this description. In general, the program module 1414 may, when loaded into the processing unit 1402 and executed, transform the processing unit 1402 and the overall computer 1400 from a general-purpose computing system into a special-purpose computing system. The processing unit 1402 may be constructed from any number of transistors or other discrete circuit elements, which may individually or collectively assume any number of states. More specifically, the processing unit 1402 may operate as a finite-state machine, in response to executable instructions contained within the program module 1414. These computer-executable instructions may transform the processing unit 1402 by specifying how the processing unit 1402 transitions between states, thereby transforming the transistors or other discrete hardware elements constituting the processing unit 1402.

Encoding the program module 1414 may also transform the physical structure of the computer-readable storage media. The specific transformation of physical structure may depend on various factors, in different implementations of this description. Examples of such factors may include, but are not limited to: the technology used to implement the computer-readable storage media, whether the computer-readable storage media are characterized as primary or secondary storage, and the like. For example, if the computer-readable storage media are implemented as semiconductor-based memory, the program module 1414 may transform the physical state of the semiconductor memory, when the software is encoded therein. For example, the program modules 1414 may transform the state of transistors, capacitors, or other discrete circuit elements constituting the semiconductor memory.

As another example, the computer-storage media may be implemented using magnetic or optical technology. In such implementations, the program modules 1314 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present disclosure.

The following provides a more detailed discussion of concepts, implementations, and corresponding results relating to aspects of the present invention in accordance with some embodiments.

Multifilter Phase Imaging

Some aspects of multifilter phase imaging (MFPI) will now be described. Basic principles of MFPI were first introduced by Paganin et al. [17] and later adapted by Zuo et al. [21] to include derivatives estimated by higher-order finite difference methods. It was found that the previously developed finite difference methods [18-20] may be generalized in terms of a digital signal processing approach in which the z derivative is estimated via convolution with a Savitzky-Golay differentiation filter (SGDF) [21]. This convolution solution is equivalent to least squares polynomial fitting, where the order of the polynomial fit corresponds to the order m of the SGDF [21]. Only odd orders in are considered because the SGDFs for each odd order are identical to the next highest even order, e.g., 1 and 2, 3 and 4, etc. [21].

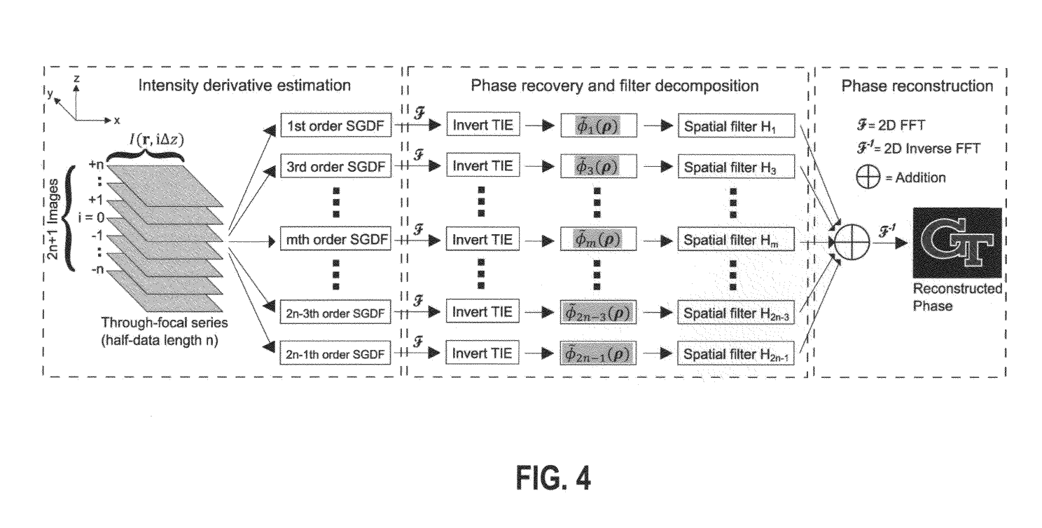

Following the derivation of Pogany et al. [24], the three-dimensional image intensity distribution for a generic weakly scattering two-dimensional object may be fully specified in terms of the combination of phase and amplitude optical transfer functions (OTFs). Since the amplitude OTF is an even function of defocus and the phase OTF is an odd function of defocus, estimating the z derivative via convolution with a SGDF results in a decoupling of the phase and amplitude information because the SGDF is a type III FIR filter that is also odd-symmetric. Because of the fact that inversion of the TIE in the Fourier domain (for a pure phase object) amounts to the application of an inverse Laplacian filter, a simple change of variables then allows the TIE estimated phase to be described in terms of a low-pass filtered version of the actual phase as described in and given by Eq. (25) of [21]. This phase transfer function (PTF) defines the relationship between the estimated phase and the actual object phase. Knowing the PTF associated with each SGDF allows the phase information to be combined in the spatial frequency domain, resulting in a composite phase that effectively increases the signal-to-noise ratio across a broad range of frequencies. This is the essence of the MFPI method and is summarized by the block diagram in FIG. 4. When the illumination is partially spatially coherent, the PTFs derived in [21] are no longer valid and need to be rederived; however, the MFPI method may still be applied if the partially coherent PTFs are known.

In order to formulate the problem and adapt the PTFs, the model used in describing the three-dimensional image intensity distribution must account for partial spatial coherence. For an ideal Köhler illuminated system, the image intensity distribution can be expressed in terms of a two-dimensional defocused OTF theory [25] or a three-dimensional OTF theory [26], which are related to each other via a one-dimensional Fourier transform along the optical axis (z direction) [25]. Both derivations rely on a weakly scattering approximation for which once-scattered light interferes only with un-scattered light so that bilinear terms may be neglected [25, 26]. Alternatively, a coherent mode decomposition (CMD) [27] may also be used to express the resulting intensities as the summation of appropriately apertured intensities due to each off-axis point of the extended source. The three-dimensional OTF formalism of Streibl can be used to derive the PTFs corresponding to SGDFs of various orders. Some numerical simulations described in a later section (under “Simulation Results”) are based on a CMD model, and the equivalence of these two approaches is described in that section. In [26], the image intensity spectrum for a telecentric imaging system is given by

\tilde{I}(ρ,η)=Bδ(ρ,η)+\tilde{P}(ρ,η)T_{ρ}⁽³⁾(ρ,η)+\tilde{A}(p,η)T_{A}⁽³⁾(ρ,η) (2)

where B is the background intensity, \tilde{P} and Ã are three-dimensional object phase and amplitude spectra corresponding to real and imaginary parts of the scattering potential, and Tₚ⁽³⁾ and T_{A}⁽³⁾ are the three-dimensional phase and amplitude OTFs. The variables ρ and η correspond to lateral and longitudinal spatial frequency coordinates, respectively, where ρ=ρₓ\hat{ρ}ₓ+ρ_{y}\hat{ρ}_{y} and pₓ and ρ_{y} are conjugate to spatial variables x and y and η is conjugate to z. For two-dimensional objects that are thinner than the Rayleigh depth of focus, the η dependence may be removed from \tilde{P} and A by inverse Fourier transformation. The OTFs for a paraxial system with circular apertures are given by Eqs. (31) and (32) in [26] and depend on the sizes of the source and pupil. The resulting shapes of the OTFs are primarily determined by the coherence parameter S of the incident illumination, Eq. (3), where NA_{cond} and NA_{obj} are the numerical apertures (NAs) of the condenser and objective lenses, respectively, and 0≦S≦1:

S=NA_{cond}/NA_{obj} (3)

The quantities Ĩ, \tilde{P} and Ã, each possess Hermitian symmetry since I, \tilde{P}, and A are each real-valued functions. It then follows that Tₚ⁽³⁾(ρ,η)=−Tₚ⁽³⁾(ρ,−η) and T_{A}⁽³⁾(ρ,η)=T_{A}⁽³⁾(ρ,−η) so that phase information may be decoupled from amplitude information as in the coherent case. The in-focus intensity derivative is estimated by convolution with a SGDF, h_{SG}(iΔz), as shown in Eq. (4), where n is the half-data length, i is the image number, aiare the SGDF coefficients, where (Δz) is the distance between defocused planes, j is the image number, and iΔz=0 is the in-focus plane:

$$\frac{d I ( r , 0 )}{d z} = {\sum }_{i = - n}^{n} \frac{{α}_{i} I ( r , iΔ z )}{Δ z} , \qquad ( 4 )$$

It then follows from the convolution and Fourier central slice theorems that the lateral Fourier spectrum of the derivative estimate may be represented by integrating the phase OTF multiplied by the SGDF frequency response, H_{SG}(e^{i2πη}), along the axial spatial frequency coordinate, Eq. (5):

$$\begin{matrix}\frac{d \overline{I} ( ρ )}{d z} = \tilde{φ} ( ρ ) {T}_{P}^{( 2 )} ( ρ ) , & ( 5 a ) \\ {T}_{P}^{( 2 )} ( ρ ) = \frac{4 π}{λ} \int {H}_{SG} ( {e}^{j2πη} ) {T}_{P}^{( 3 )} ( ρ , η ) d η , & ( 5 b )\end{matrix}$$

Where \tilde{φ} in Eq. (5) corresponds to the two-dimensional object phase spectrum and j=\sqrt{−1}. Equation (5b) defines the phase contrast transfer function (PCTF) under finite amounts of defocus. If the SGDF band-width is larger than the OTF support, the axial frequency response in Eq. (5b) may be replaced by an ideal differentiation filter, and the weakly defocused (WD) PCTF derived in [16] is then recovered as

$${T}_{Pw}^{( 2 )} ( ρ ) = \frac{4 π}{λ} \int j2πη {T}_{P}^{( 3 )} ( ρ , η ) d η . \qquad ( 6 )$$

The PCTF implied by the TIE (for a pure phase object) is easily identified by inspection of the TIE in the Fourier domain, Eq. (7a) and therefore the PCTF is given by Eq. (7b), where λ̅ is mean wavelength of the quasi-monochromatic illumination and ρ=|ρ|. The background intensity B is given by Eq. (25) in [26]:

$$\begin{matrix}\frac{d \overline{I} ( ρ )}{d z} = \tilde{φ} ( ρ ) 2 π \overline{λ} B {ρ}^{2} , & ( 7 a ) \\ {T}_{PTIE}^{( 2 )} ( ρ ) = 2 π \overline{λ} B {ρ}^{2} , & ( 7 b )\end{matrix}$$

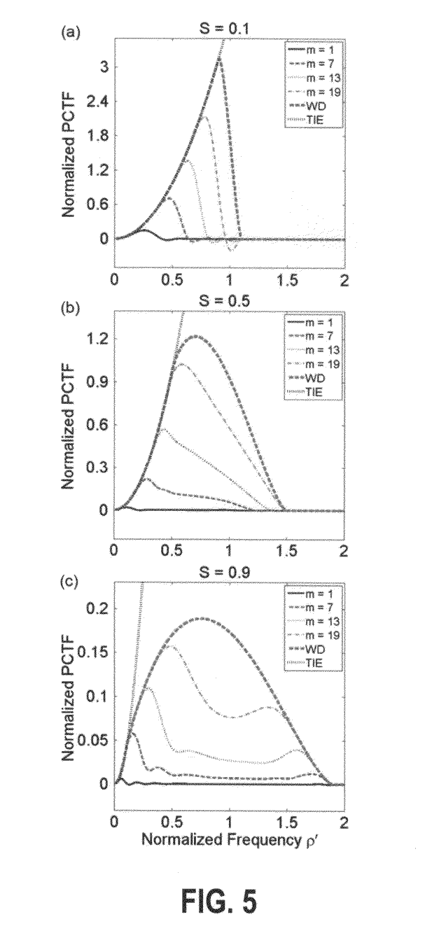

FIG. 5 shows the normalized PCTFs under finite defocus for a few SGDF orders m and coherence parameters S of 0.1, 0.5, and 0.9, where NA_{obj} is 0.75 and λ̅ is 546 nm. The half-data length n of the defocused image stack is 15, and the distance between symmetrically defocused planes Δz is 0.6 μm. For consistency, these same parameters will be used throughout the present disclosure. The WD and TIE PCTFs are also plotted in FIG. 5 for reference.

As can be seen in [28], regardless of S, the axial width of the three-dimensional OTF is greatest at the normalized frequency ρ′=1, even though this does not correspond to the maximum frequency transmitted. Consequently the spatial filters used in the decomposition phase of the partially coherent MFPI (MFPI-PC) take on a slightly different form. The form and cut-off frequencies of the spatial filters are defined by Eq. (8), where ρ_{c} is a lateral cut-off frequency for the spatial filter corresponding to a specific SGDF order m and ξ is a constant that defines the cut-off ratio. The inventors' experiments have yielded good results with ξ=0.99; however, its exact value represents another noise-resolution trade-off:

ξ=T_{P}⁽²⁾(ρ_{c})/T_{Pw}⁽²⁾(ρ_{c}) (8)

For larger values of S there may be two cut-off frequencies, corresponding to a lower and upper cutoff, which define upper and lower bounds for the frequency range that can accurately be estimated with the corresponding SGDF. Each Fourier component of the resulting composite phase should be estimated using the lowest-order SGDF possible since the noise effect is effectively suppressed by lower orders.

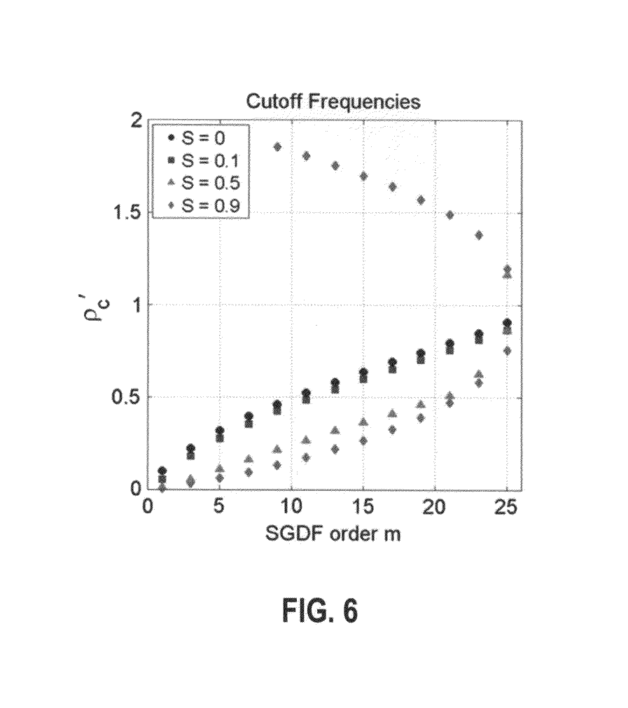

There is no simple relationship for the cut-off frequencies, as they depend in general on n, m, Δz, S, NA_{obj}, and λ̅. FIG. 6 depicts the normalized cut-off frequencies calculated using Eq. (8) for odd orders m=1 through 25 and the same coherence parameters as in FIG. 5. The normalized lower and upper cutoffs converge to 1 as m is increased. The cut-off frequencies for the coherent case (S=0) are also plotted in FIG. 6 for reference.

The partially coherent PTFs are given by dividing the estimated PCTF by the implicit TIE PCTF:

PTF(ρ)=T_{P}⁽²⁾(ρ)/T_{PTIE}⁽²⁾(ρ) (9)

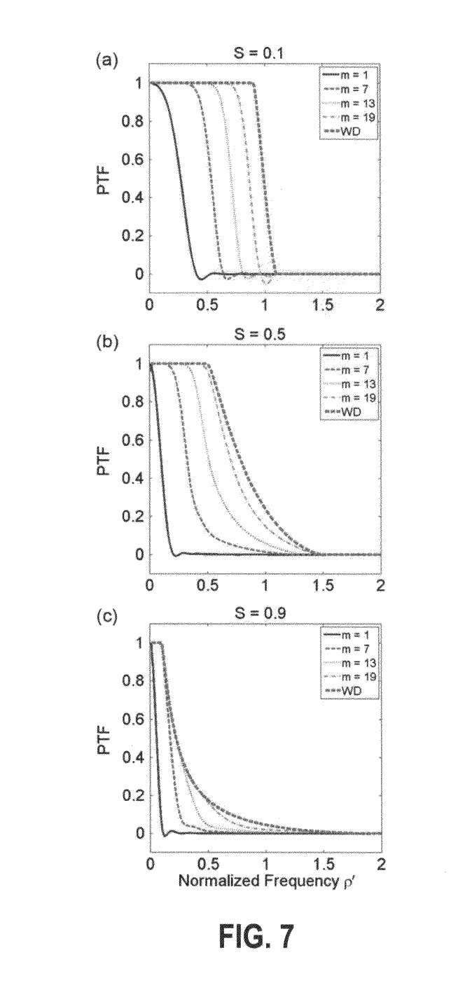

PTFs under finite defocus are plotted in FIG. 7 again for the same parameters as in FIG. 2. The WD PTFs are also included for reference. It can be seen that the theoretical resolution using this method is improved as S is increased at the cost of reduced contrast over a broad range of spatial frequencies due to aperture effects. When the MFPI-PC method is used, the composite PTF approaches the WD PTF without increasing noise sensitivity, as verified numerically and experimentally, described in the following sections.

Simulation Results

An alternative, and intuitive, description of a Köhler illuminated imaging system comes by way of a CMD. Using this method a partially coherent wave-field may be decomposed into statistically independent coherent modes with well-defined phases [27]. Because each mode is statistically independent, the resulting intensity pattern is the summation of intensities due to each mode [27]. For a delta-correlated source, the coherent modes correspond to individual plane waves propagating through the object with various inclination angles. Therefore, the intensity pattern resulting from an arbitrary object can be easily modeled by summing together the intensities due to a large number of off-axis plane waves that have been apertured appropriately. The equivalence of the CMD formulation with the OTF theory described above can be demonstrated by a numerical example.

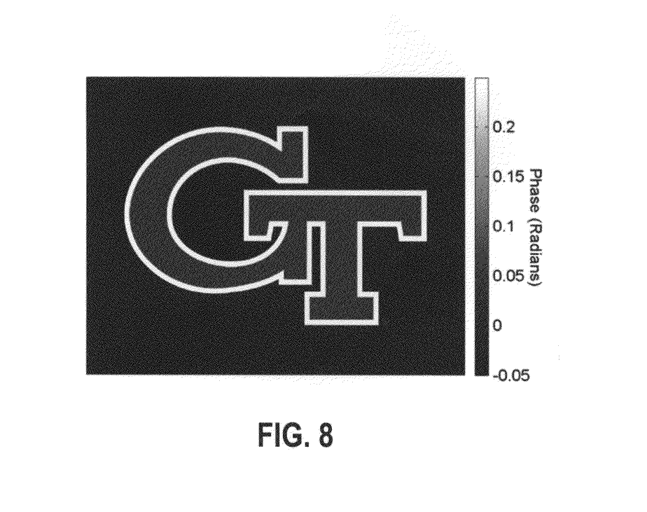

Using the CMD method, the intensities due to a weakly scattering phase object consisting of the letters “GT” as shown in FIG. 8 are simulated. The units of the simulated phase object are radians. The simulation parameters match those for the “Multifilter Phase Imaging” section above, and the grid dimensions are 1030×1300 with a square pixel size of 0.245 μm×0.245 μm. In each simulation, the illuminating aperture was uniformly discretized into 40 intervals in each direction of the lateral spatial frequency domain resulting in around 1256 individual plane waves. A Fresnel propagation kernel is used to mimic the paraxial approximation inherent in [26]. No noise was added in order to directly compare the simulated results to those predicted by OTF theory. The PTFs are found by simply dividing the phase spectra estimated using a fixed-order m by the simulated phase spectrum. In every case, the resulting radially averaged PTFs obtained from the simulation were indiscernible from the PTFs obtained with OTF theory as plotted in FIG. 7, indicating that the two formulations are equivalent.

Lifting the paraxial approximation and using a spherical propagator instead results in error upon inversion of the TIE since it is based on a paraxial approximation. These errors are, in general, non-negligible for high-NA imaging systems and large coherence parameters. For the cases highlighted here, the nonparaxial results show reasonable agreement with the paraxial theory.

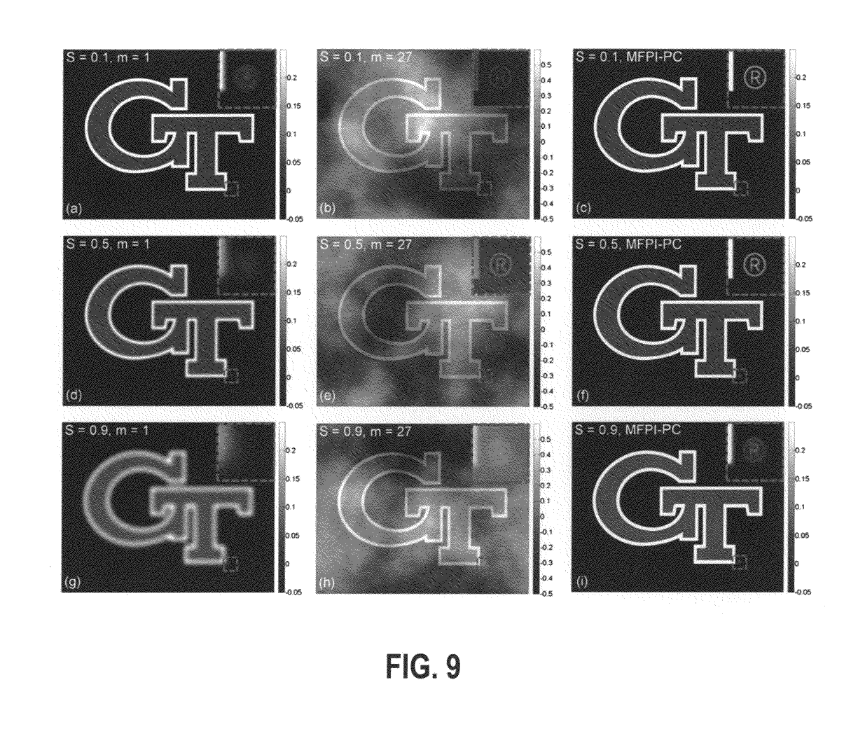

FIG. 9 displays the phases recovered after adding white Gaussian noise with normalized standard deviation σ=0.002 to each simulated intensity image, where σ defines the ratio of the noise standard deviation to the mean image intensity level, meaning that the amount of noise added was 0.2% of the background intensity. If a first-order SGDF is used, as in (a), (d), and (g) of FIG. 9, a blurry version of the original phase image is obtained along with the addition of a small amount of low spatial frequency noise artifacts. Although the registered trademark symbol ®, located near the base of the “T” in “GT”, is not discernible in any case, the blurring is more severe as S is increased, since the longitudinal width of the three-dimensional phase OTF dramatically increases with S for low- to mid-range spatial frequencies [18]. If a 27th-order SGDF is used, as in (b), (e), and (h) of FIG. 9, the resolution improves as the registered trademark symbol ® becomes discernible in each case. However, using a large-order m results in dramatically increased noise sensitivity due to overfitting. If the MFPI-PC method is applied, combining odd orders m=1 through 27 and using the cut-off frequencies shown in FIG. 6, the resulting composite phase spectrum approximates the simulated phase spectrum multiplied by the corresponding WD PTF without adding severe noise, and (c), (f), and (i) of FIG. 9 provide verification. The noise artifacts are of the same level as the first-order estimates, and the resolution features demonstrate some anticipated characteristics. In each case the registered trademark symbol ® is discernible; however, its magnitude is reduced as S is increased due to aperture effects.

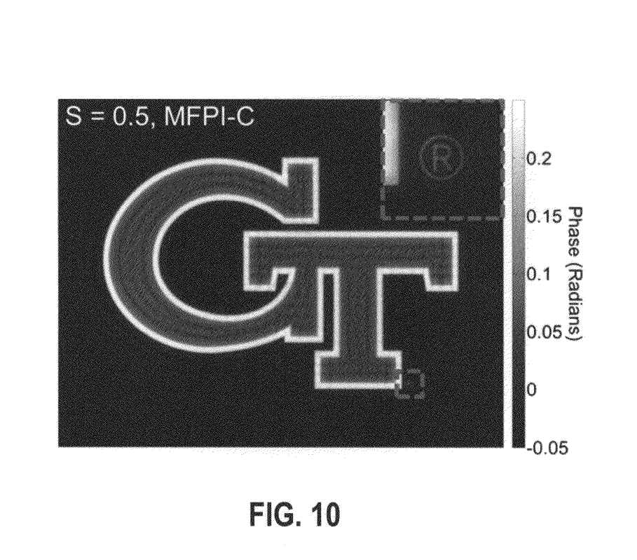

FIG. 10 displays the phase recovered using the established coherent MFPI (MFPI-C) method on partially coherent intensity data, S=0.5, without taking partial spatial coherence into account. In this simulation the same level of Gaussian noise (σ=0.002) was added, and the cutoffs for S=0 and m=1 through 27 (also shown in FIG. 6) were used. Although the noise reduction is satisfactory because the first-order SGDF is used for most of the low spatial frequencies, the overall reconstruction has been severely impacted by the improper placement of filter cut-off frequencies, resulting in the unnecessary attenuation of certain spatial frequencies. This effect is manifested in the reconstructed phase as oscillating features emanating from the object edges. Another evidence of this effect is that the registered trademark symbol ® is reduced in amplitude when compared with (f) in FIG. 9. Therefore, it can be difficult to extract quantitative information about the object phase for arbitrary spatial frequencies using reconstructions based on the MFPI-C theory alone. Generally, the MFPI-PC theory can be needed to interpret the z derivative and subsequent phase estimates correctly.

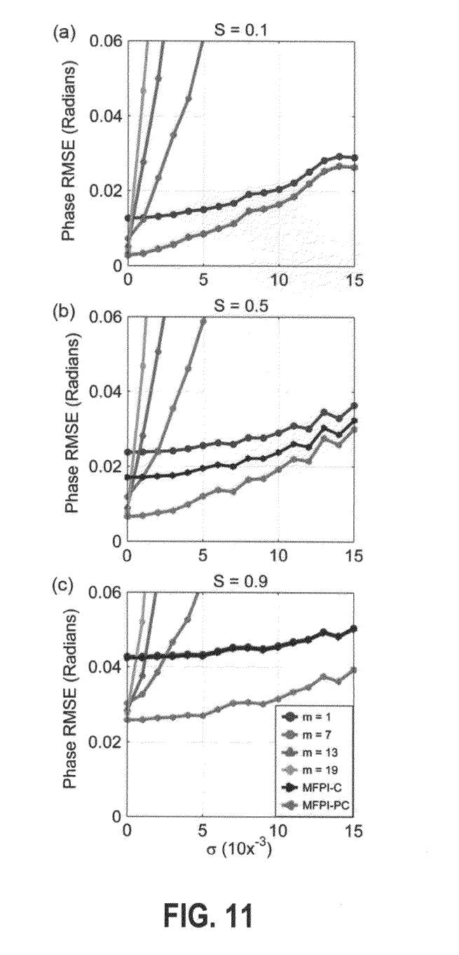

To demonstrate the effectiveness of the MFPI-PC method in the presence of severe noise, the phase root mean squared errors (RMSEs) as a function of simulated normalized noise standard deviations from σ=0 to 0.015 for the cases when S=0.1, 5=0.5, and S=0.9 are plotted in FIG. 11. The errors were calculated 10 times and averaged to reduce uncertainty. For all cases the same general behavior set forth in [21] is observed in which the lower-order estimates are more robust against noise but possess larger error with small noise levels due to the lack of spatial resolution. For a given noise level, there is a fixed-order m that produces the lowest RMSE on average. However, with the MFPI-PC method, the full spatial resolution of the highest order is available and the RMSE is consistently lower because it judiciously stitches together the best portions from each phase estimate. The results also show that the MFPI-PC method is robust in the presence of high levels of noise as the slope of its RMSE with σ is only slightly larger than that of the first-order estimate for all cases. For comparison, the resulting RMSE for the MFPI-C method is also plotted. When S=0.1, the illumination is nearly coherent so that the MFPI-PC and MFPI-C results are nearly indiscernible; the MFPI-PC methodology is more general and converges to the MFPI-C method with decreasing coherence parameters as can be seen by examining the cutoffs in FIG. 3 for S=0.1 and S=0. When S=0.5, it can be seen that the MFPI-PC results are better. This is due to the unnecessary attenuation of certain spatial frequency ranges due to improper placement of filter cut-off frequencies, which produces the ringing artifacts evidenced by FIG. 10. When S=0.9, the MFPI-C results approach the m=1 results because the lower cut-off frequencies for each filter order are much higher than they should be, resulting in severe attenuation for most frequency ranges. The MFPI-PC method correctly accounts for these effects and removes much of the blur typically present when attempting TIE phase recovery using relatively incoherent illumination.

It should be recognized that the optimal choice of distance between planes Δz was also investigated as a function of various parameters including σ, n, and S. Generally, Δz can be selected such that the bandwidth of the highest-order SGDF used is equal to the longitudinal frequency support of the three-dimensional OTF. Choosing Δz to be larger than this value can result in a loss of spatial resolution, and choosing Δz to be smaller can result in the unnecessary amplification of noise.

Experimental Results

To verify some theoretical assessments discussed herein, the phase shift induced by a visible blazed transmission grating (Thorlabs GT13-03, grating period Λ=3.33 μm, blaze angle θ_{B}=17.5°, Schott B270 glass n_{glass}=1.5251) was measured using the proposed method with the same parameters as described in the “Multifilter Phase Imaging” section above. The imaging system was realized with an Olympus BX60 microscope and a UPlanFl 40×/0.75 objective. The grating was mounted face up on a glass slide with refractive index matching oil (Cargille Labs nₒᵢₗ=1.4620) and a 0.17 mm coverslip. Applying the periodic boundary conditions inherent in the FFT-based solution to the TIE to the periodic grating results in large low-frequency phase shifts that are not related to image noise or background phase. To suppress this effect without rendering the result nonquantitative, the composite phase images were high-pass filtered with a cut-off frequency defined by half of the first harmonic frequency of the grating, thereby also removing background effects and most of the noise. Results presented here generally demonstrate the resolution characteristics of MFPI-PC without much noise influence. The noise effects are demonstrated later using an optical fiber as a test object. For a discussion on the effects of various boundary conditions on TIE solvers, see [29].

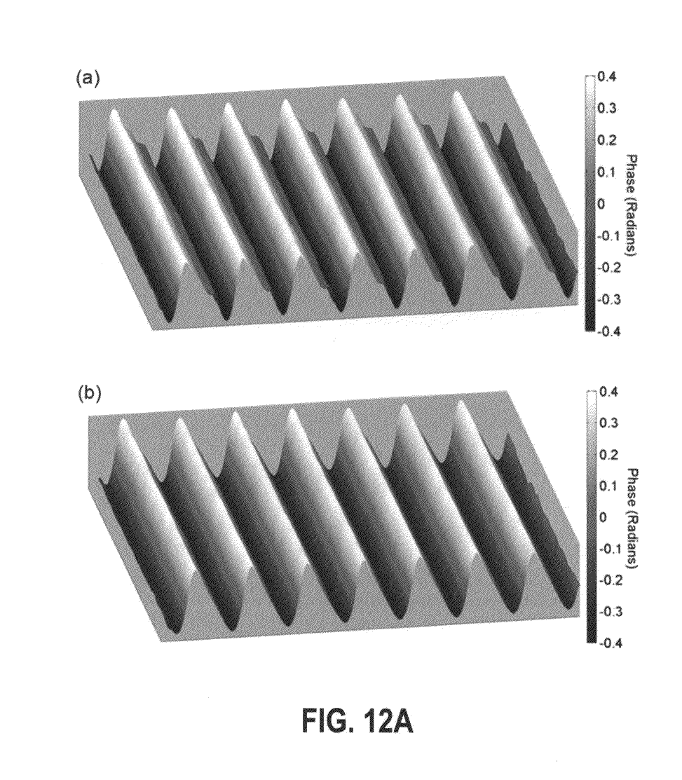

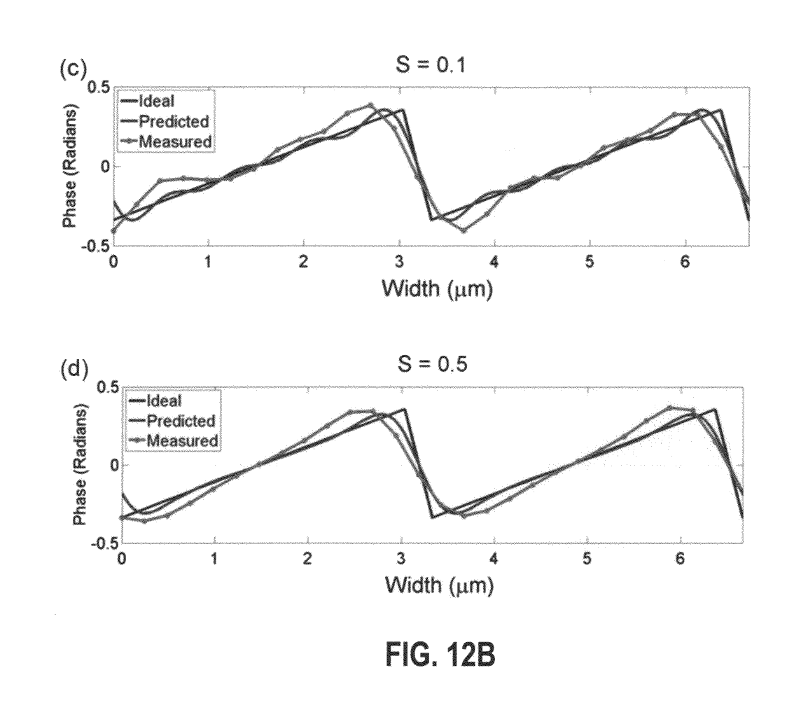

The measured phase profiles for a 100×100 pixel square patch are represented in (a) and (b) of FIG. 12A as surface plots for S=0.1 and 0.5. The results are interpolated for ease of viewing. Also plotted in (c) and (d) of FIG. 12B are a few periods of the associated line profiles with no interpolation. Plotted for reference are the ideal profiles, assuming 90° groove angles, as well as the predicted results determined by filtering the ideal profiles with the appropriate WD PTF. In both cases there is good agreement between the measured profile and the predicted profile. The hard aperture effects are visible in the measured profile for S=0.1 as evidenced by the rapid oscillations. The soft aperture/extended resolution effects are visible for S=0.5 as evidenced by the smooth profile and slightly reduced amplitude. Results for S=0.9 did not necessarily match theory well because the measured intensities exhibited a high degree of asymmetry about the focal plane, due to spherical aberration associated with the non-corrected thickness of the refractive index matching oil between the grating and the coverslip. In order to increase accuracy for large S, objective lenses with correction collars may be used to ensure symmetry in the microscope point spread function.

To demonstrate the joint noise/resolution capability of MFPI-PC, the refractive index distribution of a single-mode optical fiber (Corning SMF-28) was reconstructed tomographically using filtered back-projection [30]. As part of this reconstruction, phase profiles are measured every 2° using the same parameters as in the “Simulation Results” section above for S=0.5, which is solidly in the partially coherent regime. The fiber experiment was conducted using the same equipment and procedures outlined in [31] with the exception that the defocusing was achieved using a piezoelectric microscope objective scanner (Physik Instrumente P-721.SL2), and the same defocus parameters as the “Simulation Results” section above were used. For all measurements, the fiber was suspended in refractive index matching oil between two coated fiber pieces and rotated about its axis, and the overall experimental setup is as shown in [31].

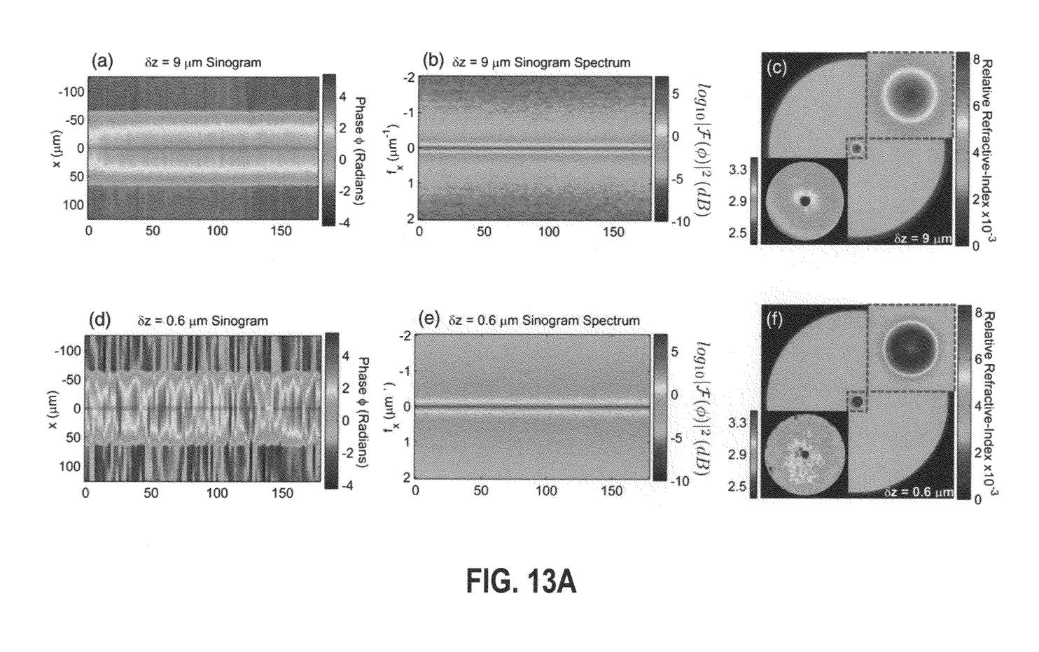

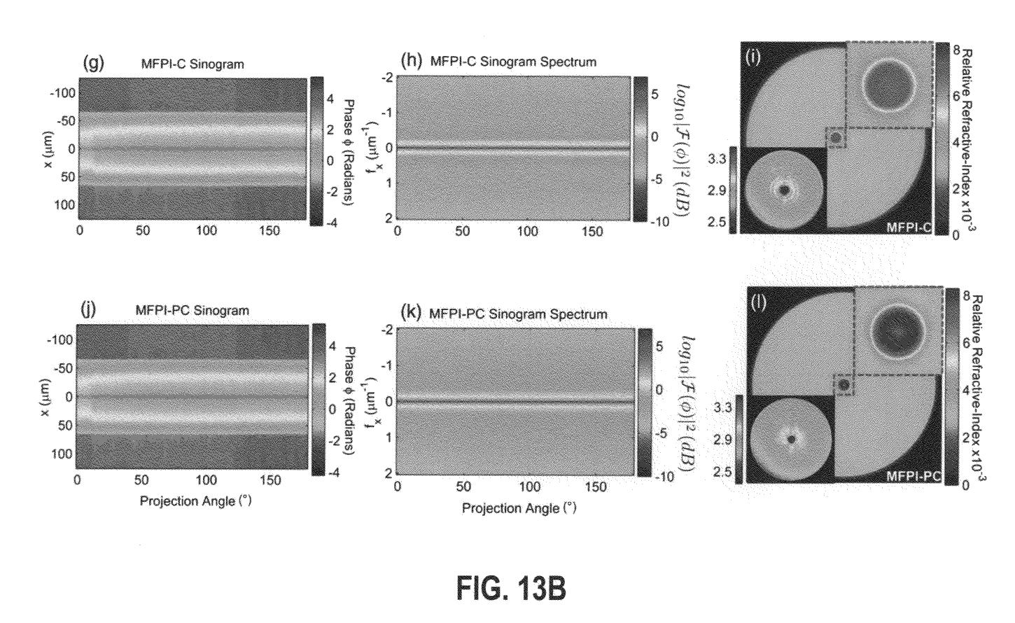

The resulting sinograms and tomograms are presented in FIGS. 13A and 13B. In these figures, four separate methods, including conventional TIE phase recovery using defocus distances of (δz) 9 and 0.6 μm as well as MFPI-C and MFPI-PC (organized by row from top to bottom), were used to estimate the fiber phase shift. Organized by column are three separate representations of the data, including (from left to right) the phase sinogram, the Fourier spectrum of the phase sinogram (represented as the logarithm of the squared magnitude of the data), and lastly the resulting cross-sectional refractive index distribution. In (a) of FIG. 13A there is little variation in the recovered phase profiles versus projection angle because the fiber is radially symmetric and the noise performance is in direct proportion to the defocus distance, which is large. Likewise for (d) in FIG. 13A there are large variations (manifested as slowly varying features in the x direction) from angle to angle due to the small defocus distance used. However, in (b) of FIG. 13A it can be seen that much of the high spatial frequency content (in this figure fₓ is the conjugate frequency variable for x) has been severely attenuated in the large defocus distance case when compared to the spectrum in (e) of FIG. 13A. This results in a loss of radial spatial resolution, which can be seen by comparing the cross-sectional tomograms in (c) and (f) of FIG. 13A. The top-right insets in these figures display a zoomed-in version of the fiber core. Due to the fiber manufacturing process, there is a dip in refractive index that results in the center of the core, and the reconstruction in (f) of FIG. 13A is sharp enough to resolve this feature, whereas the reconstruction in (c) of FIG. 13A displays a profile that is similar to a Gaussian in shape. The effects of noise are seen by examining the variations in the cladding, which are displayed in the bottom-left insets where the colorbar limits have been altered to enhance contrast. In (f) of FIG. 13A, the presence of noise is manifested as cladding variation and is much less uniform than in (c) of FIG. 13A. It should be recognized that projection tomography can work well with TIE phase recovery to reduce noise overall because the phase noise features are proportional to 1/f2/x and these same features are later processed with a filter proportional to fₓ as part of the filtered backprojection algorithm resulting in tomogram noise that is proportional to 1/fₓ only.

In (g)-(i) of FIG. 13B, the phase has been recovered using the established MFPI-C method, and in (j)-(l) of FIG. 13B, the phase has been recovered using the MFPI-PC methodology. Although MFPI-C appears to have resulted in good noise suppression and nonattenuated frequency content, the cross section in (i) of FIG. 13B has some artifacts that are not evident in the other tomograms. The core-cladding refractive index difference may be estimated by manual inspection of the tomogram data and is found to be ˜4.4×10⁻³ for the MFPI-C case and ˜5.1×10⁻³ for the MFPI-PC case, a difference of ˜14%. The latter of these two approximations is in agreement with previously published data based on microinterferometry [32]. In addition to an inaccurate core index estimate, there are ringing artifacts manifested in the cladding that also result from the unnecessary attenuation of certain spatial frequency ranges. Lastly, capability of the MFPI-PC method to suppress noise and enhance resolution simultaneously without introducing measurement inaccuracy is manifested in (j)-(l) of FIG. 13B. In (j) of FIG. 13B, there is little to no variation in phase across projection angles. In (k) of FIG. 13B, significant attenuation of high spatial frequencies is not observed. In (l) of FIG. 13B, both of these effects are manifested in the highly uniform cladding and the presence of a sharp center dip in refractive index. No ringing artifacts are observed, and the measured core-cladding index difference matches previously published data well [32].

It should be recognized that MFPI-PC performs well in this scenario regardless of the fact that two assumptions inherent to its derivation are violated. The fiber is not a weak phase object as the maximum phase shift is approximately 3.6 radians. Similarly, others have also found phase retrieval by means of direct inversion of the weak OTF to be surprisingly robust with strong phase objects [33]. The weak phase approximation |φ(r)−φ(r−Δzρ)|<<1 is a relative condition dependent on wavelength, defocus, and spatial frequency and MFPI naturally tends to pair large spatial frequencies with small defocus distances and vice versa. Also, the fiber is not a thin object as its diameter is much larger than the depth of focus. In [34] it was found that for simple geometries the OTF theory produces accurate phase values if the object thickness along the optical axis is less than its lateral width.

Numerous characteristics and advantages have been set forth in the foregoing description, together with details of structure and function. While various embodiments of the processing systems and methods have been disclosed in exemplary forms, many modifications, additions, and deletions can be made without departing from the spirit and scope of the present invention and its equivalents as set forth in the following claims. Therefore, other modifications or embodiments as may be suggested by the teachings herein are particularly reserved as they fall within the breadth and scope of the claims here appended.

### REFERENCES

[1] F. Zernike, “Phase contrast, a new method for the microscopic observation of transparent object,” Physica (Amsterdam) 9, 686-698 (1942).
[2] G. Nomarski and A. R. Weill, “Application à la métallographie desméthodes interférentielles à deux ondes polarisées,” Rev. Metall. 2, 121-128 (1955).
[3] G. Popescu, Quantitative Phase Imaging of Cells and Tissues (McGraw-Hill, 2011).
[4] Z. Wang, L. Millet, M. Mir, H. Ding, S. Unarununotai, J. Rogers, M. U. Gillette, and G. Popescu, “Spatial light interference microscopy (SLIM),” Opt. Express 19, 1016-1026 (2011).
[5] B. L. Bachim and T. K. Gaylord, “Microinterferometric optical phase tomography for measuring small, asymmetric refractive-index difference in the profiles of optical fibers and fiber devices,” Appl. Opt. 44, 316-327 (2005).
[6] C. L. Zheng, K. Scheerschmidt, H. Kirmse, I. Hausler, and W. Neumann, “Imaging of three-dimensional (Si, Ge) nanostructures by off-axis electron holography,” Ultramicroscopy 124, 108-116 (2013).
[7] P. Bon, S. Lecart, E. Fort, and S. Leveque-Fort, “Fast label-free cytoskeletal network imaging in living mammalian cells,” Biophys. J. 106, 1588-1595 (2014).
[8] R. Wang, Z. Wang, L. Millet, M. U. Gillette, A. J. Levine, and G. Popescu, “Dispersion-relation phase spectroscopy of intracellular transport,” Opt. Express 19, 20571-20579 (2011).
[9] M. Mir, Z. Wang, Z. Shen, M. Bednarz, R. Bashir, I. Golding, S. G. Prasanth, and G. Popescu, “Optical measurement of cycle-dependent cell growth,” P. Natl. Acad. Sci. USA 108, 13124-13129 (2011).
[10] M. Mir, Z. Wang, K. Tangella, and G. Popescu, “Diffraction phase cytometry: blood on a CD-ROM,” Opt. Express 17, 2579-2585 (2009).
[11] M. Mir, H. F. Ding, Z. Wang, J. Reedy, K. Tangella, and G. Popescu, “Blood screening using diffraction phase cytometry,” J. Biomed. Opt. 15(2), 027016 (2010).
[12] Z. Wang, K. Tangella, A. Balla, and G. Popescu, “Tissue refractive index as marker of disease,” J. Biomed. Opt. 16(11), 11601 (2011).
[13] J. R. Fienup, “Reconstruction of an object from the modulus of its Fourier transform,” Opt. Lett. 3, 27-29 (1978).
[14] M. R. Teague, “Deterministic phase retrieval: a Green's function solution,” J. Opt. Soc. Am. 73, 1434-1441 (1983).
[15] J. C. Petruccelli, L. Tian, and G. Barbastathis, “The transport of intensity equation for optical path length recovery using partially coherent illumination,” Opt. Express 21, 14430-14441 (2013).
[16] E. D. Barone-Nugent, A. Barty, and K. A. Nugent, “Quantitative phase-amplitude microscopy I: optical microscopy,” J. Microsc. 206, 194-203 (2002).
[17] D. Paganin, A. Barty, P. J. McMahon, and K. A. Nugent, “Quantitative phase-amplitude microscopy III. The effects of noise,” J. Microsc. 214, 51-61 (2004).
[18] M. Soto and E. Acosta, “Improved phase imaging from intensity measurements in multiple planes,” Appl. Opt. 46, 7978-7981 (2007).
[19] L. Waller, L. Tian, and G. Barbastathis, “Transport of intensity phase-amplitude imaging with higher order intensity derivatives,” Opt. Express 18, 12552-12560 (2010).
[20] R. Bie, X. H. Yuan, M. Zhao, and L. Zhang, “Method for estimating the axial intensity derivative in the TIE with higher order intensity derivatives and noise suppression,” Opt. Express 20, 8186-8191 (2012).
[21] C. Zuo, Q. Chen, Y. J. Yu, and A. Asundi, “Transport-of-intensity phase imaging using Savitzky-Golay differential filter—theory and applications,” Opt. Express 21, 5346-5362 (2013).
[22] L. Waller, “Phase imaging with partially coherent light,” Proc. SPIE 8589, 85890K (2013).
[23] J. Long, M. Jenkins, and T. K. Gaylord, “Comparison of transport-of-intensity derivative methods for optical fibers under partially coherent illumination,” in Frontiers in Optics 2013, OSA Technical Digest (Optical Society of America, 2013), paper FTh1F.3.
[24] A. Pogany, D. Gao, and S. W. Wilkins, “Contrast and resolution in imaging with a microfocus x-ray source,” Rev. Sci. Instrum. 68, 2774-2782 (1997).
[25] C. J. R. Sheppard, “Defocused transfer function for a partially coherent microscope and application to phase retrieval,” J. Opt. Soc. Am. A 21, 828-831 (2004).
[26] N. Streibl, “3-dimensional imaging by a microscope,” J. Opt. Soc. Am. A 2, 121-127 (1985).
[27] A. M. Zysk, R. W. Schoonover, P. S. Carney, and M. A. Anastasio, “Transport of intensity and spectrum for partially coherent fields,” Opt. Lett. 35, 2239-2241 (2010).
[28] C. Sheppard, “Three-dimensional phase imaging with the intensity transport equation,” Appl. Opt. 41, 5951-5955 (2002).
[29] J. Martinez-Carranza, K. Falaggis, T. Kozacki, and M. Kujawinska, “Effect of imposed boundary conditions on the accuracy of transport of intensity equation based solvers,” Proc. SPIE 8789, 87890N (2013).
[30] A. C. Kak and M. Slaney, Principles of Computerized Tomographic Imaging (IEEE, 1988).
[31] M. R. Hutsel and T. K. Gaylord, “Concurrent three dimensional characterization of the refractive-index and residual-stress distributions in optical fibers,” Appl. Opt. 51, 5442-5452 (2012).
[32] B. L. Bachim, T. K. Gaylord, and S. C. Mettler, “Refractive index profiling of azimuthally asymmetric optical fibers by microinterferometric optical phase tomography,” Opt. Lett. 30, 1126-1128 (2005).
[33] S. S. Kou, L. Waller, G. Barbastathis, P. Marquet, C. Depeursinge, and C. J. R. Sheppard, “Quantitative phase restoration by direct inversion using the optical transfer function,” Opt. Lett. 36, 2671-2673 (2011).
[34] C. J. Bellair, C. L. Curl, B. E. Allman, P. J. Harris, A. Roberts, L. Delbridge, and K. A. Nugent, “Quantitative phase amplitude microscopy IV: imaging thick specimens,” J. Microsc. 214, 62-69 (2004).
[35] T. E. Gureyev, “Transport of intensity equation for beams in an arbitrary state of temporal and spatial coherence.” Optik, vol. 110, pp. 263-266, 1999.
[36] K. A. Nugent, D. Paganin, and T. E. Gureyev, “A phase odyssey,” Phys. Today, vol. 54, pp. 27-32, 2001.
[37] L. J. Allen and M. P. Oxley, “Phase retrieval from series of images obtained by defocus variation,” Opt. Commun., vol. 199, pp. 65-75, 2001.
[38] T. E. Gureyev and K. A. Nugent, “Phase retrieval with the transport-of-intensity equation. II. Orthogonal series solution for nonuniform illumination,” J. Opt. Soc. Am. A, vol. 13, pp. 1670-1682, 1996.

What is claimed is:

1. A method of quantitative phase imaging, comprising:
acquiring a through-focal series of defocused images of an object illuminated with a partially coherent light source;
calculating a plurality of estimates of longitudinal intensity derivatives for respective fittings of the series of defocused images;
recovering a phase estimate for each respective estimate of the longitudinal intensity derivative by solving a transport of intensity (TIE) equation;
filtering the recovered phase estimates to produce component parts of an overall phase estimate; and
forming an overall phase image by addition of the filtered phase estimates.

2. The method of claim 1, wherein acquiring the through-focal series of defocused images comprises sampling the images at unequally spaced intervals placed symmetrically about the in-focus position of the object.

3. The method of claim 1, wherein acquiring the through-focal series of defocused images comprises sampling the images at equally spaced intervals placed symmetrically about the in-focus position of the object.

4. The method of claim 1, wherein the object is illuminated with Köhler illumination from an extended incoherent source.

5. The method of claim 1, wherein calculating the plurality of estimates of the longitudinal intensity derivative comprises applying differentiation filters.

6. The method of claim 5, wherein the differentiation filters are Savitzky-Golay differentiation filters.

7. The method of claim 5, wherein applying the differentiation filters comprises applying n differentiation filters having a length of 2n+1 and orders corresponding to odd numbered integers from 1 to 2n−1, wherein n is an integer.

8. The method of claim 1, wherein the respective fittings of the series of defocused images comprise polynomial fittings.

9. The method of claim 1, wherein acquiring the through-focal series of defocused images comprises collecting the defocused images in parallel using a plurality of detectors and at least one beam splitter.

10. The method of claim 1, wherein recovering the phase estimate for each respective estimate of the plurality of estimates of the longitudinal intensity derivative by solving the TIE equation comprises solving the TIE equation using at least one of Fourier-based methods, Green's function methods, multi-grid methods, and Zernike methods.

11. The method of claim 1, wherein filtering the phase estimates to produce the component parts of the overall phase estimate comprises applying Fourier-based functions.

12. The method of claim 1, wherein filtering the phase estimates to produce the component parts of the overall phase estimate comprises applying a low-pass filter to the first degree phase estimate, a high-pass filter to the 2n−1 degree phase estimate, and band-pass filters for degrees other than the first degree phase estimate and the 2n−1 degree phase estimate.

13. The method of claim 12, wherein each of the low-pass filter, high-pass filter, and band-pass filters comprises a binary masking filter.

14. The method of claim 12, wherein the low-pass filter, high-pass filter, and band-pass filters are selected according to filter cut-off frequencies coincident with the frequency at which the ratio of a corresponding phase contrast transfer function to the weakly-defocused phase contrast transfer function falls to a predetermined value for balancing signal-to-noise ratio and spatial resolution.

15. A system for quantitative phase imaging, comprising:
a partially coherent light source configured to illuminate an object;
an image acquisition device configured to acquire a through-focal series of defocused images of the object illuminated with the partially coherent light source;
a memory device;
a processor coupled to the image acquisition device and the memory device, configured to execute instructions stored in the memory device to cause the system to:
calculate a plurality of estimates of longitudinal intensity derivatives for respective fittings of the series of defocused images;
recover a phase estimate for each respective estimate of the longitudinal intensity derivative by solving a transport of intensity (TIE) equation;
filter the recovered phase estimates to produce component parts of an overall phase estimate; and
form an overall phase image by adding the filtered phase estimates.

16. The system of claim 15, wherein acquiring the through-focal series of defocused images comprises sampling the images at unequally spaced intervals placed symmetrically about the in-focus position of the object.

17. The system of claim 15, wherein acquiring the through-focal series of defocused images comprises sampling the images at equally spaced intervals placed symmetrically about the in-focus position of the object.

18. The system of claim 15, wherein calculating the plurality of estimates of the longitudinal intensity derivative comprises applying n differentiation filters having a length of 2n+1 and orders corresponding to odd numbered integers from 1 to 2n−1, wherein n is an integer.

19. The system of claim 18, wherein the differentiation filters are Savitzky-Golay differentiation filters.

20. The system of claim 15, wherein the respective fittings of the series of defocused images comprise polynomial fittings.

21. The system of claim 15, wherein the image acquisition device comprises at least one beam splitter in optical communication with a plurality of detectors configured such that the through-focal series of defocused images are collected in parallel.

22. The system of claim 15, wherein the image acquisition device comprises an object translation stage and acquiring the through-focal series of defocused images comprises applying at least one defocus aberration using the object translation stage.

23. The system of claim 15, wherein the image acquisition device comprises an objective scanner and applying the through-focal series of defocused images comprises applying at least one defocus aberration using the objective scanner.

24. The system of claim 15, wherein the image acquisition device comprises an infinity corrected optical system.

25. The system of claim 15, wherein recovering the phase estimate for each respective estimate of the plurality of estimates of the longitudinal intensity derivative by solving the TIE equation comprises solving the TIE equation using at least one of Fourier-based methods, Green's function methods, multi-grid methods, and Zernike methods.

26. The system of claim 15, wherein filtering the phase estimates to produce the component parts of the overall phase estimate comprises applying Fourier-based functions.

27. The system of claim 15, wherein filtering the phase estimates to produce the component parts of the overall phase estimate comprises applying a low-pass masking filter to the first degree phase estimate, a high-pass masking filter to the 2n−1 degree phase estimate, and band-pass masking filters for degrees other than the first degree phase estimate and the 2n−1 degree phase estimate.

28. The system of claim 27, wherein the low-pass filter, high-pass filter, and band-pass filters are selected according to filter cut-off frequencies coincident with the frequency at which the ratio of a corresponding phase contrast transfer function to the weakly-defocused phase contrast transfer function falls to a predetermined value for balancing signal-to-noise ratio and spatial resolution.

29. A non-transitory computer-readable medium storing instructions that, when executed by a processor, cause a computer to perform a method for quantitative phase imaging, the method comprising:
acquiring a through-focal series of defocused images of an object illuminated with a partially coherent source;
calculating a plurality of estimates of longitudinal intensity derivatives for respective fittings of the series of defocused images;
recovering a phase estimate for each respective estimate of the longitudinal intensity derivative by solving a transport of intensity (TIE) equation;
filtering the recovered phase estimates to produce component parts of an overall phase estimate; and
forming an overall phase image by adding the filtered phase estimates.

30. The computer-readable medium of claim 29, wherein acquiring the through-focal series of defocused images comprises sampling the images at unequally spaced intervals placed about the in-focus position of the object.

31. The computer-readable medium of claim 29, wherein acquiring the through-focal series of defocused images comprises sampling the images at equally spaced intervals placed about the in-focus position of the object.

32. The computer-readable medium of claim 29, wherein the respective fittings of the series of defocused images comprise polynomial fittings.

33. The computer-readable medium of claim 29, wherein acquiring the through-focal series of defocused images comprises collecting the defocused images in parallel.

34. The computer-readable medium of claim 29, wherein recovering a phase estimate for each respective estimate of the longitudinal intensity derivative by solving the TIE equation comprises solving the TIE equation by at least one of Fourier-based methods, Green's function methods, multi-grid methods, and Zernike methods.

35. The computer-readable medium of claim 29, wherein filtering the phase estimates to produce the component parts of the overall phase estimate comprises applying Fourier-based functions.

36. The computer-readable medium of claim 29, wherein filtering the phase estimates to produce the component parts of the overall phase estimate comprises applying a low-pass masking filter to the first degree phase estimate, a high-pass masking filter to the 2n−1 degree phase estimate, and band-pass masking filters for degrees other than the first degree phase estimate and the 2n−1 degree phase estimate.

37. The computer-readable medium of claim 36, wherein the low-pass filter, high-pass filter, and band-pass filters are selected according to filter cut-off frequencies coincident with the frequency at which the ratio of a corresponding phase contrast transfer function to the weakly-defocused phase contrast transfer function falls to a predetermined value for balancing signal-to-noise ratio and spatial resolution.
